(19) United States
(12) Patent Application Publication
(10) Pub. No.: US 2005/0039611 A1
(43) Pub. Date: Feb. 24, 2005

(54) Pivotable grid for a barbecue grill

(76) Inventor: Daniel R. Nett, Germantown, WI (US)

Correspondence Address: D. Peter Hochberg, Esq.;D. Peter Hochberg Co., L.P.A., 6th Floor, 1940 E. 6th Street, Cleveland, OH, 44114, US

(21) Appl. No.: 10/644,353

(22) Filed: Aug. 20, 2003

(51) Int. Cl. A47J 9/00

(52) U.S. Cl. 99/450

(57) ABSTRACT

A portable, multi-level barbecue grill assembly having a base cavity, a lid, a pivot assembly, a lower cooking grid and an upper warming grid. The upper warming rack is pivotally secured to the lid and to the pivot assembly. The pivot assembly comprises a pair of lift arms and a pair of pivot extensions for raising the pivot axis of the upper warming grid. When the grill is opened, the upper grid pivots about an axis above the lower grid, thereby providing an increased amount of space between the upper and lower grids. When the grill is closed, the pivot axis of the upper grid moves towards the lower grid to provide a compact storage condition.

### FIELD OF THE INVENTION

The present invention relates to barbecue grills. More particularly, the present invention relates to a multi-level barbecue grill having improved and more efficient cooking and warming surface structures.

### BACKGROUND OF THE ART

Barbecue grills for both indoor and outdoor use are commonly used and are well known in the art. Such grills generally have at least a lower, cooking surface for cooking food thereon and many have an upper, warming surface for keeping food warm, but far enough away from a heat source so as not to overcook or bum the food. Generally, the upper surface pivots on a pivoting system to a relatively close distance to the lower surface when the grill is closed. When the grill is open, the upper surface pivots upwardly and rearwardly, thereby creating a greater distance between the respective surfaces.

The difference in distances between the upper surface and the lower surface when the grill is closed as compared to when the grill is open tends to be small. This small difference in the distance between the surfaces prevents the person using the grill (the griller) from having adequate access to the rearward area of the lower surface for food placement and retrieval. In order to facilitate access to the rearward area of the lower surface, the conventional upper surfaces tend to be constructed with a relatively small depth between the front and rear ends of the upper surface when compared to the lower surface, at times up to 50% less, thereby having a significantly smaller surface area. The small size of the upper surface facilitates access to the rearward area of the lower surface, but prevents room for sufficient amounts of food to be placed thereon for warming. The lesser the amount of food that can be cooked and warmed on the grill, the less efficient the grill is. This leads to a greater amount of time being spent by the griller to cook food on the grill, thereby causing more fuel to be used over a longer period of time.

There is a need for a more efficient multilevel barbecue grill having a lower cooking surface/grid and an upper warming surface/grid with greater surface areas, the upper warming surface/grid being pivotable relative to the lower surface.

### SUMMARY OF THE INVENTION

The present invention is an improved, easy to assemble, barbecue grill. The grill includes a lower cooking surface situated directly above a heat source, such as a charcoal or briquette pit or a propane gas assembly, and an upper warming surface that is parallel to the cooking surface, but disposed directly above it. The upper surface is pivotally secured to the lid of the grill, and when the grill is opened, the upper surface pivots upwardly and rearwardly in response to the opening of the grill. A pair of pivot extensions are provided for raising the pivot point level of the upper surface. When the grill is closed, the upper surface is at a level above the lower surface that is slightly higher than that of conventional grills. When the grill is opened, the upper surface raises to a level above the lower surface that is significantly higher than conventional grills, by way of the pivot extensions. Because there is a significantly greater space between the upper surface and the lower surface when the grill is opened, the problem of inadequate access to the rearward area of the lower surface is greatly reduced, if not eliminated. The increased space between the surfaces allows the upper surface to have a greater surface area than conventional upper surfaces, thereby increasing the overall efficiency of the grill.

It is an object of the present invention to provide a barbecue grill having improved efficiency regarding food cooking and warming capabilities.

It is another object of the present invention to provide a barbecue grill having a lower cooking surface with improved access to the rearward area of the lower surface.

It is yet another object of the present invention to provide a barbecue grill having an increased distance between the upper surface and the lower surface when the grill is opened and when the grill is closed.

It is still yet another object of the present invention to provide a barbecue grill having an upper warming surface that raises to a higher level relative to the lower cooking surface than a comparably sized conventional barbecue grill.

It is another object of the present invention to provide a barbecue grill that is easy to assemble.

It is yet another object of the present invention to provide a barbecue grill that has a compact structure.

It is still yet another object of the present invention to provide a barbecue grill that is portable.

These and other objects of the invention may occur to those skilled in the art from the description to follow and from the appended claims.

### BRIEF DESCRIPTION OF THE DRAWINGS

FIG. 1 is a perspective view of the barbecue grill of the present invention in an opened state.

FIG. 2 is a detailed rear view of the barbecue grill of the present invention showing part of the hinging structure of the cover of the grill and the bowl of the grill.

FIG. 3 is a top view of the barbecue grill of the present invention showing the grill in a closed state.

FIG. 4 is a side, internal view of the barbecue grill of the present invention, showing the barbecue grill in both an opened state and a closed state, superimposed on each other, with the grill in its opened state shown in dotted lines.

FIG. 5 is another perspective view of the barbecue grill of the present invention, with the cover shown in its open condition.

FIG. 6 is a perspective view of the barbecue grill of the present invention with its legs extended.

FIG. 7 is a perspective view of the barbecue grill of the present invention with its legs being closed.

FIG. 8 is a perspective view of the interior components of an alternative embodiment of the barbecue grill of the present invention having the grill in both opened and closed positions being superimposed upon one another, with the components shown in dotted lines in the open condition of the grill.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It will be evident, however, to one skilled in the art that the present invention may be practiced without these specific details.

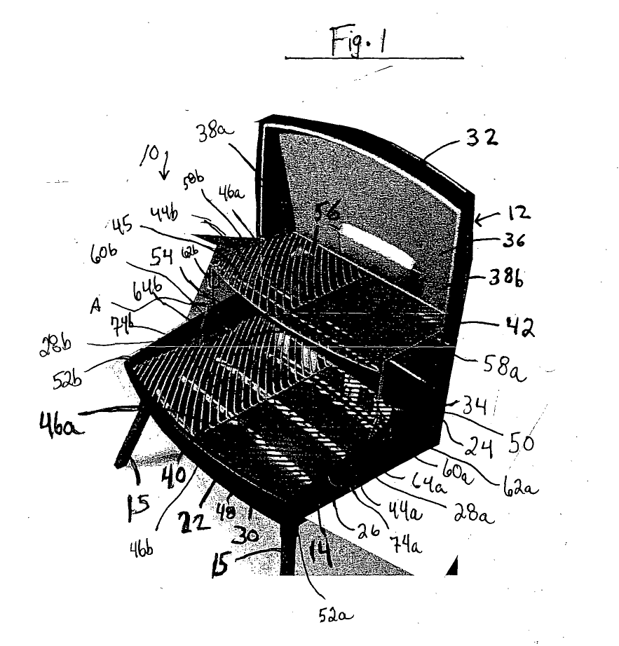

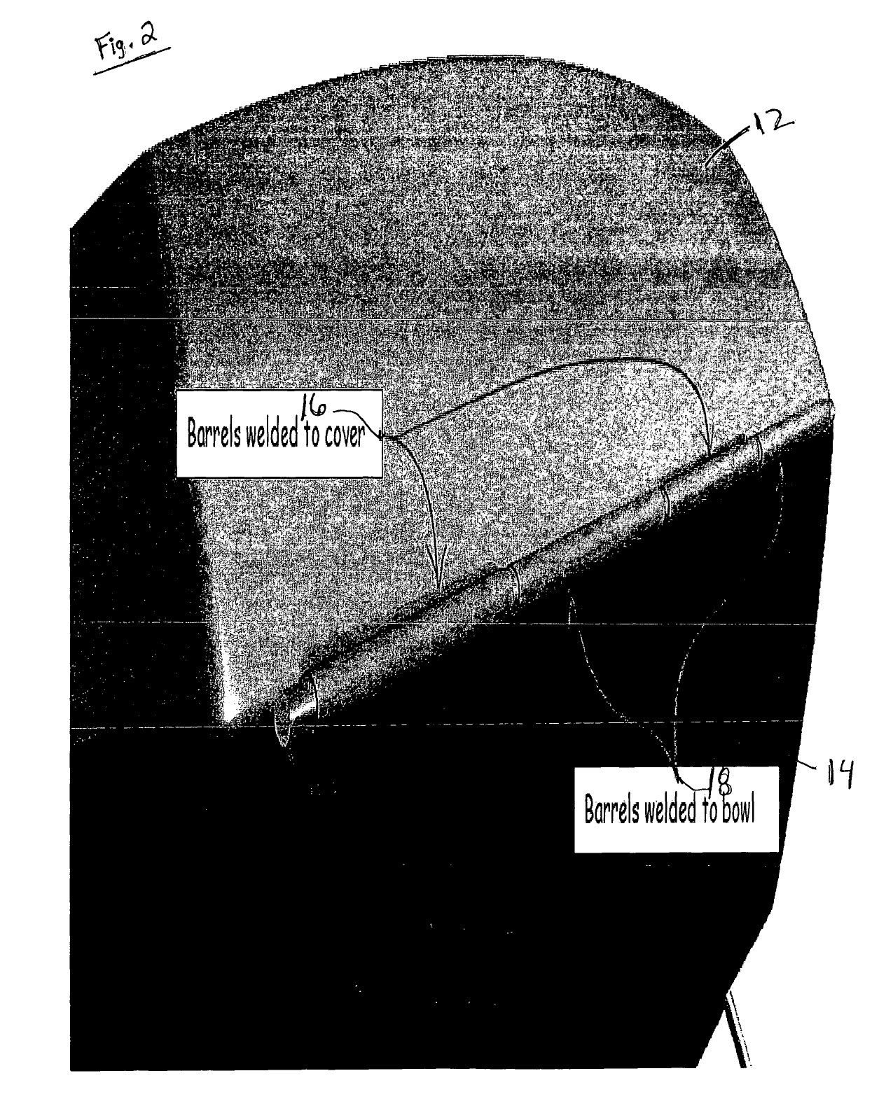

Referring now to FIG. 1, one embodiment according to the present invention is shown at numeral 10 as a barbecue grill. Grill 10 includes a lid 12 secured to a bowl 14 or base cavity and a plurality of legs 15 extending downwardly from bowl 14. Lid 12 and bowl 14 may be secured to each other by way of any conventional method known in the art. For example, as shown in FIG. 2, lid barrels 16 may be secured to lid 12 at the base of the rear of lid 12 and bowl barrels 18 may be secured to bowl 18 at the top of the rear of bowl 18, both, for example, by welding or any other comparable method. A cylindrical shaft or post 20 extends through the cylindrical bores of barrels 16 and 18, about which barrel 16 may pivot or rotate when lid 12 is lifted off of bowl 14 in order to obtain access in bowl 14.

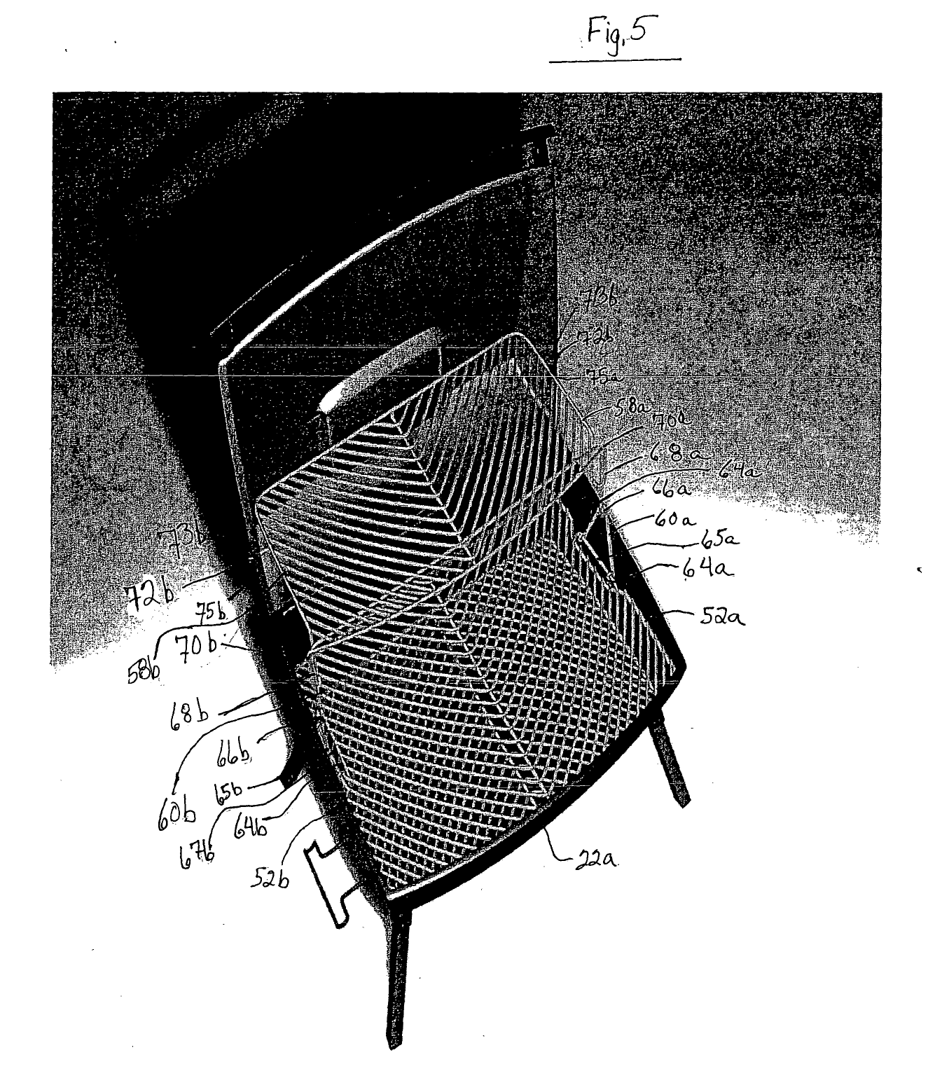

Bowl 14 includes a front wall 22, a back wall 24, a bottom wall 26 and a pair of sidewalls 28a, b. Front wall 22, back wall 24, bottom wall 26 and pair of sidewalls 28a, b are secured together in a substantially square formation to define a basin 30 for containing a heat source, such as charcoal or a propane gas assembly, with bottom wall 26 forming the floor of bowl 14. Although bowl 14 and lid 12 are shown as being substantially square, it should be appreciated that grill 10 can have any other shape conventional in the art, such as rectangular or circular. Sidewalls 28a, b are substantially straight and are parallel to each other. Front wall 22 is secured to each of sidewalls 28a, b at a substantially right angle; however front wall 22 includes a bowed portion 22a in order to provide front wall 22 with a curved appearance when viewed from the top view when grill 10 is opened (FIG. 5).

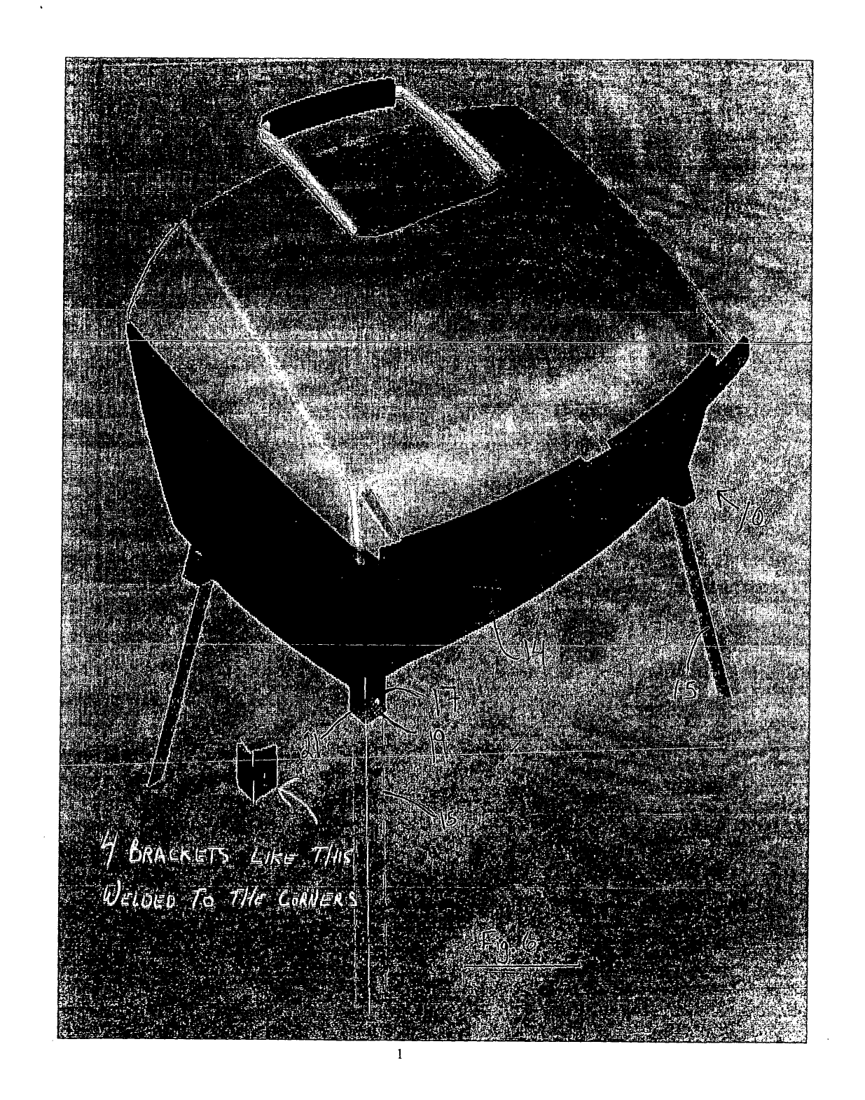

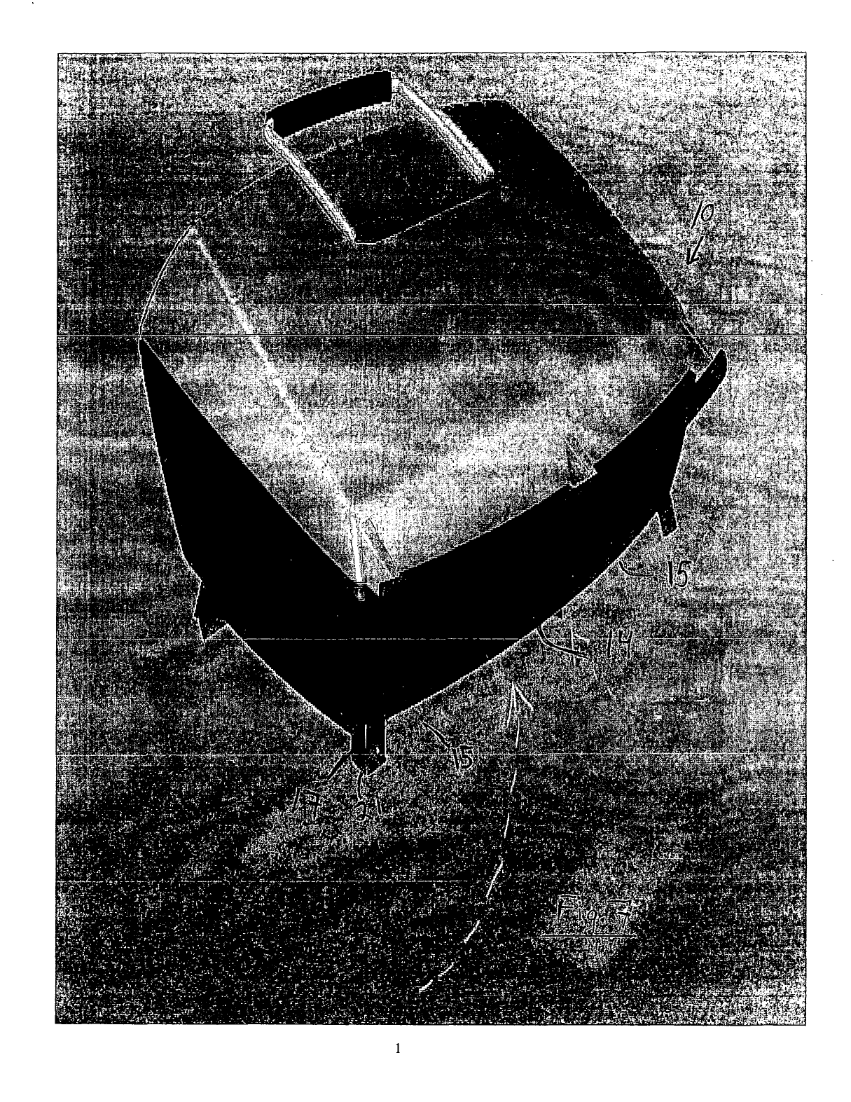

Referring now to FIGS. 6 and 7, plurality of legs 15 is shown with legs 15 opened and extending downwardly from the underside of bowl 14. Legs 15 can extend directly downwardly from bowl 14, or they can alternatively extend downwardly at an angle in order to better stabilize grill 10 on the ground. A bracket 17, shown in detail in FIG. 6a, having a hole 19, being secured to the underside of bowl 14 on each corner of bowl 14 by way of welding or the like, extends downwardly from the underside of bowl 14. When grill 10 is not being used, or when legs are not required as when grill 10 is seated on a ledge or the like, legs 15 are able to be manually released from a locked position and folded inwardly to rest along the underside of bowl 14, as demonstrated in FIG. 7. An outwardly biased pin or button 21 is provided which can be pushed in order to release legs 15 from the locked position. When legs 15 are extended outwardly into a locked position for use of grill 10, pin 21 extends through hole 17 and through aligned holes in legs 15 in order to lock legs 15 into place. It should be appreciated that any other comparable type of locking mechanism may be used in order to secure legs 15 into a locked position during use of grill 10.

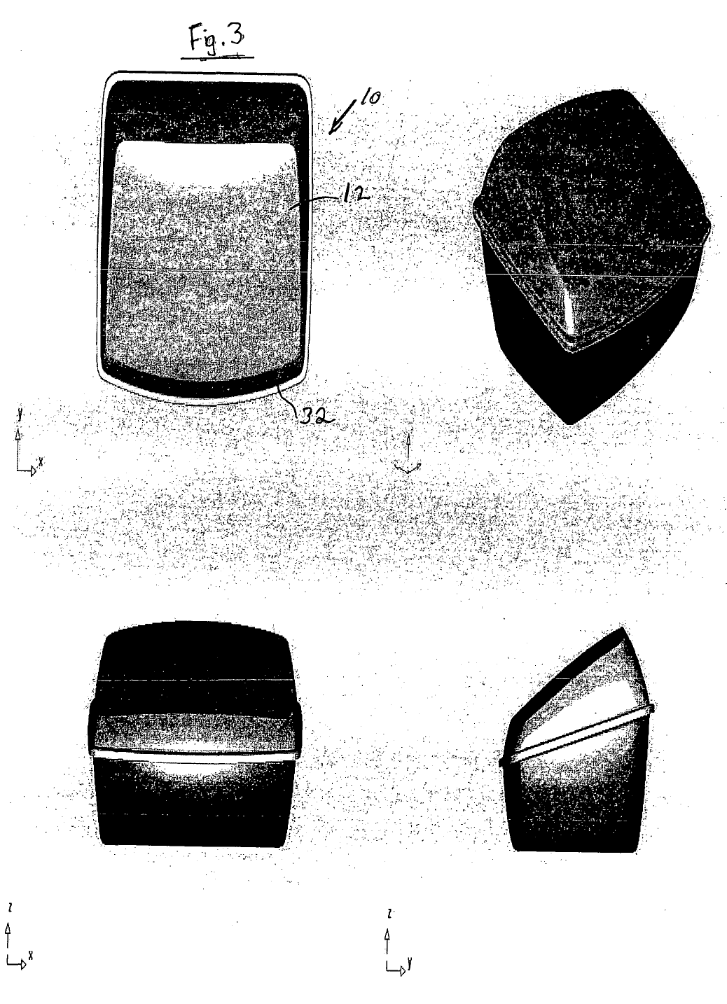

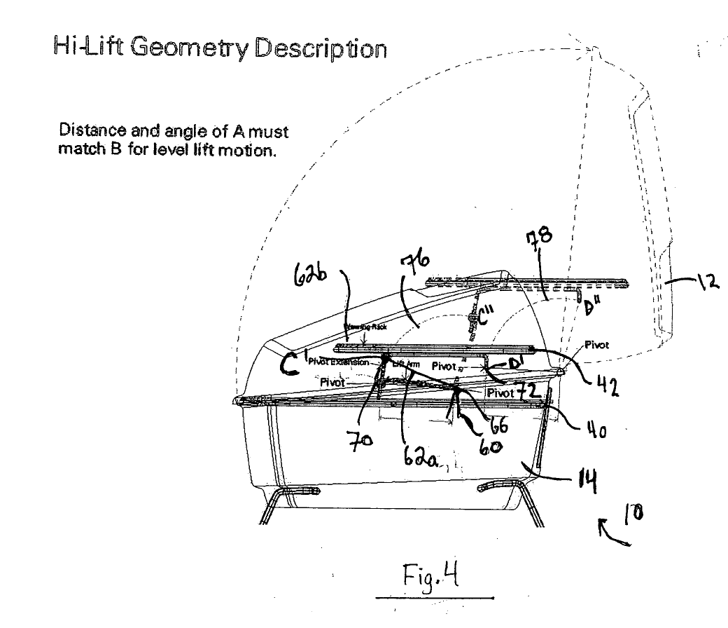

Referring back to FIGS. 1 and 4, lid 12 includes a lid front wall or front rim 32, a lid back wall 34, a top wall 36 and a pair of lid sidewalls 38a, b. As seen in FIG. 1, each of walls 32, 34, 36 and 38a, b have substantially the same shape as the respective corresponding walls 22, 24, 26, and 28a, b of bowl 14 so that when grill 10 is closed, the lower ends of each of the walls of lid 12 abuts with the corresponding upper ends of the walls of bowl 14 to form a secure seal. Front wall 32, back wall 34, bottom wall 36 and pair of sidewalls 38a, b are secured together in a substantially square cross-sectional formation which corresponds to the top of bowl 14, with top wall 36 forming the ceiling of lid 12. Sidewalls 38a, b are substantially straight and are parallel to each other. Front wall 32 is secured to each of sidewalls 38a, b at a substantially right angle; however front wall 32 also includes a substantially bowed portion in order to provide front wall 32 with a curved appearance when viewed from the top view when grill 10 is closed (FIG. 3).

Grill 10 still further includes a pair of grids, one being a lower, cooking grid 40 and the other being an upper, warming grid 42. Both of grids 40 and 42 are made of any conventional material known in the art, such as stainless steel, and are composed of a plurality of diagonally disposed rungs 44a, b, which are shown as being slightly curved. The plurality of rungs 44a, b are shown in FIG. 1 as extending diagonally from a central rung 46a, b towards the back and either to the left or right side of either lower grid 40 or upper grid 42. This of course is just one grid design of a variety of known designs, any one of which may be incorporated into grids 40 and 42, none of which have any bearing on the improved functionality of grids 40 and 42.

Lower grid 40 includes a curved front edge 48 generally corresponding to the curve of portion 22a of bowl front wall 22, a straight rear edge 50 and a pair of straight, substantially parallel side edges 52a, b. Upper grid 42 also includes a curved front edge 54 parallel to the curve of front edge 48 of lower grid 40, a straight rear edge 56 and a pair of straight, substantially parallel side edges 58a, b. Each of the respective edges of lower grid 40 and upper grid 42 are disposed so as to correspond to the respective adjacent sides of either bowl 14 or lid 12. Each of the edges of grids 40 and 42 are able to be placed as close to the respective sides of bowl 14 and lid 12 as possible so as to ensure that grids 40 and 42 contain maximum surface areas, thereby ensuring a maximum cooking surface area and a maximum warming surface area. At least one pair of oppositely disposed supports 74a, b are placed in bowl 14, secured to sidewalls 28a, b, for supporting lower grid 40 in place within the cooking area of bowl 14. Alternatively, lower grid 40 may be supported by upwardly extending flanges of a sear grid if grill 10 is a gas barbecue grill.

Grill 10 further includes a pair of pivot extensions 60a, b and a pair of lift arms 62a, b. As seen in FIGS. 1, 4 and 5, pivot extensions 60a, b are triangular structures, preferably comprised of the same material as grids 40 and 42 (i.e., stainless steel). Lower grid 40 can further include a pair of oppositely disposed indentations 64a, b on each side of lower grid 40. Indentations 64a, b provide an indented area on side edges 52a, b to accommodate the securing of pivot extensions 60a, b thereon. Pivot extensions 60a, b are secured to lower grid 40 and extend upwardly therefrom in a vertical orientation so that pivot extensions 60a, b are substantially perpendicular to the plane in which lower grid 40 is disposed.

In further detail, each pivot extension assembly includes a rod 65a, b extending partly across each of indentations 64a, 64b and parallel to side edges 52a, 52b. Pivot extensions 60a, 60b include metal rods 67a, b extending upwardly at an angle from the opposite ends of rods 65a, b and coming together at a first pair of pivots 66a, b (discussed below).

Still referring to FIGS. 1, 4 and 5, grill 10 will be described while in an opened position. First pair of pivots 66a, b are disposed on the top of pivot extensions 60a, b. For example, pivot 66a is secured to the top of pivot extension 60a and pivot 66b on top of pivot extension 60b. Pivots 66a, b are movable as discussed below. First pair of pivots 66a, b is preferably any type of conventional pivot known in the art and is preferably of the same type of material as grids 40 and 42 and pivot extensions 60a, b (i.e., stainless steel). Pivots 66a, b are formed in part by the intersections 67a, 67b. Pivot extensions 60a, b are provided so as to raise the pivot point of first pair of pivots 66a, b; that is, the pivot between a lift arm (described below) and pivot extension 60a, b from a level that is even with that of lower grid 40 to a level that is above the level of lower grid 40. By way of pivot extensions 60a, b, first pair of pivots 66a, b are raised to a level higher than that of lower grid 40, such as by about three inches in the preferred embodiment. First pair of pivots 66a, b are, in other words, about three inches higher than a conventionally disposed pivot would be, which would be at the level of lower grid 40. By employment of pivot extensions 60a, b to raise the level of pivots 66a, b, the space between lower grid 40 and upper grid 42 is increased, both while grill 10 is opened and closed. For example, a conventional grill having a grill height of about 10 inches (when the grill is closed) employs a lower grid having a surface area of about 243 in² and an upper grid having a surface area of about 112 in². The distance between the upper grid and lower grid in the aforementioned conventional grill would be about 3.75 inches when the grill is opened and about 2 inches when the grill is closed. Employment of pivot extensions 60a, b increases this distance between lower grid 40 and upper grid 42 to about 6.75 inches when the grill is opened and about 2.5 inches when the grill is closed. The increased space between the lower grid 40 and upper grid 42 does not affect the overall grill package height. In this case, it would be about 8.25 inches. Additionally, the distance between upper grid 42 and lid 12, while grill 10 is closed, would be a maximum distance of about 3.5 inches (about one inch at the front of upper grid 42), while the same maximum distance in a comparably conventional grill would be about 2 inches.

As shown in FIG. 5, extending upwardly from pivot 66a is a first lift arm 68a and extending upwardly from pivot 66b is a second lift arm 68b. Lift arms 68a, b are in turn secured to a second pair of pivots 70a, b, respectively, which provide a pivot point between lift arm 68 and upper grid 42. Second pair of pivots 70a, b are secured to upper grid 42 at the foremost comers of upper grid 42. It should be appreciated that second pair of pivots 70a, b are the same type and of the same material as first pair of pivots 66a, b, which can be any type of pivot conventional in the art. Lift arms 68a, b each comprises a metallic rod twisted or configured into a substantially rectangular loop. Each lift arm 68a, b can alternatively comprise a single straight metallic rod, multiple metallic rods or a metallic rod twisted into any other shape so long as the lift arms can easily pivot between the open and closed position of barbecue grill 10.

Referring to FIGS. 1, 4 and 5, a third pair of pivots 72a, b extends outwardly from side edges 58a, b of upper grid 42 and are disposed towards the rear edge 56 of upper grid 42. The two pivots of third pair of pivots 72a, b are disposed opposite each other on upper grid 42 and extend outwardly from upper grid 42 towards sidewalls 38a, b and through a hole 73a, b of lid 12 to pivotably secure upper grid 42 to lid 12. Third pair of pivots 72a, b provides a pivot point for upper grid 42 relative to lid 12. Pivots 72a, b both comprise a rod 75a, b secured to opposite sides of upper grid 42 and extend outwardly therefrom and through respective holes 73a, b on the sidewall of lid 12. Rod 75a, b can be secured by a nut, such as a wing-nut, can be snap-fit into place, or secured by any other comparable securing method or apparatus to facilitate pivoting of upper grid 42 in response to movement of lid 12 between an open and closed position.

Turning now to FIG. 4, the opened and closed positions of grill 10 are shown in a superimposed manner. For the sake of clarity and brevity, only one of any of the aforementioned pairs of features included in grill 10 will be discussed below. While grill 10 is in a closed position, lift arm 62a extends outwardly from first pivot 66a in a horizontal manner, substantially parallel to both lower grid 40 and upper grid 42. While in this position, second pivot 70a, the pivot between the top of lift arm 62a and upper grid 42, is in a first position C′, which is a relatively low position within grill 10, resting just above lower grid 40. While grill 10 is closed, upper grid 42 is resting just above lower grid 40 with a distance between the two of about 2.5 inches, as explained above. It is again emphasized that this distance is variable depending on the particular grill size with which the present invention is being employed. Third pivot 72a, which is the pivot that pivotably secures upper grid 42 with lid 12, is at a first position D′.

FIG. 4 also shows grill 10 in an open position. When grill 10 is opened in a clockwise direction as illustrated, second pivot 70a travels along a first path 76 to a second position, shown at C″. Likewise, third pivot 72a travels along a second path 78 to a second position, shown at D″. While grill 10 is closed, the distance between first pivot 66, which is stationary relative to a vertical and horizontal direction, and second pivot 70a is shown at distance A from first pivot 66a. The distance between third pivot 72a and the pivot (i.e. the longitudinal axis of shaft 20) between lid 12 and bowl 14 at the back of grill 10 is shown as B. According to all embodiments of the present invention, distance A is substantially equal to distance B and the angle between the pivots involved with distance A must be substantially equal to the angle between the pivots involved with distance B in order to ensure level lifting of upper grid 42 while grill 10 is in the process of being opened. Substantially equal distances and angles will ensure that upper grid 42 remains parallel to lower grid 40 while grill 10 is being opened. In other words, it is preferred that there be no more than a 10% difference between distance A and distance B and there be no greater than a 10° difference in the angles between the pivots of distance A and distance B to ensure level lifting of upper grid 42. It should be appreciated that the actual distance of A and B are not relevant to the level lifting of upper grid 42 of the present invention because the actual distance of A and B will vary depending on the size of the grill with which the present invention is being employed.

Pivot extension 60a enables upper grid 42 to lift to a higher level relative to lower grid 40 than it would when compared to the upper and lower grids of a conventional grill. This increased distance between grids 40 and 42 allows grids 40 and 42 to be constructed having surface areas that are about 18% greater than grids used in a comparably sized conventional grill. For example, when comparing grill 10 according to the present invention having an overall package height of about 8.25 inches with a comparably sized conventional grill, upper grid 42 has a surface area of 166 inches² and lower grid 40 has a surface area of 255 inches², whereas the grids of a comparably sized conventional grill would have surface areas of 112 inches² and 243 inches², respectively.

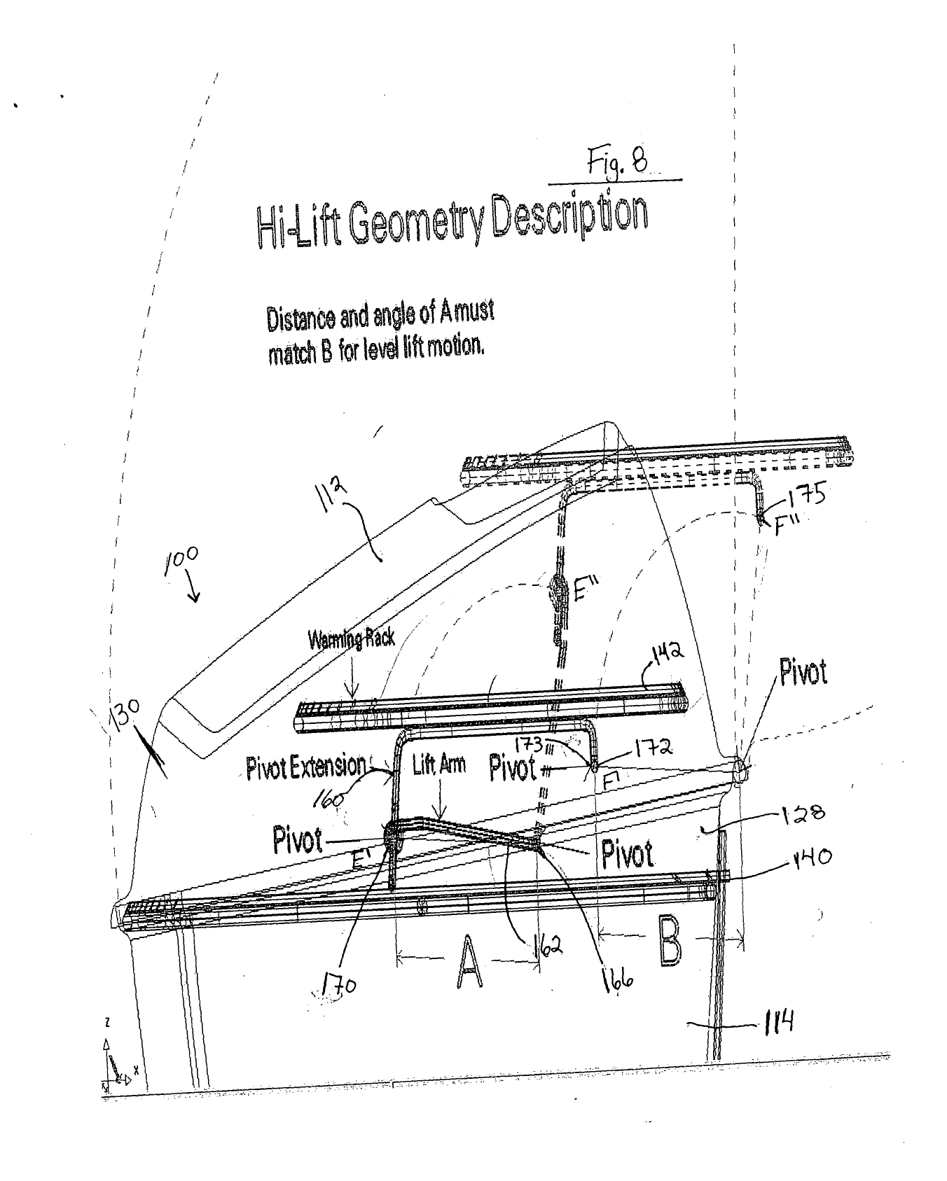

Referring now to FIG. 8, a second embodiment of the barbecue grill of the present invention is shown and referred to at numeral 100. Grill 100 includes each of the same features as the grill described above, including a lid 112, a bowl 114 having a pair of sidewalls 128, a lower grid 140, an upper grid 142, a pair of pivot extensions 160, a pair of lift arms 162, a first pair of pivots 166, a second pair of pivots 170 and a third pair of pivots 172. The remaining features of grill 10 described above are incorporated below, however a detailed description thereof is omitted for the sake of brevity. As was done above, just one of the pair of features will be discussed below for the sake of clarity.

In this embodiment, lower grid 140 is pivotably secured to sidewalls 128 by way of first pivot 166, each of first pivots 166 being disposed on an opposite side of lower grid 140. As explained earlier with respect to pivots 66a, b, pivots 166 include a pivot assembly interconnecting a lift arm 162 and pivot extension 160. When grill 100 is closed, lift arm 162 extends from first pivot 166 in a substantially horizontal fashion to a second pivot 170. Second pivot 170 pivotably secures lift arm 162 to pivot extension 160, which when grill 100 is closed, extends substantially upwardly from second pivot 170 so that lift arm 162 and pivot extension 160 are substantially perpendicular to each other. Again as discussed earlier with respect to second pivots 70a, b, second pivot 170 is comprised of a pivot assembly comprising a rod extending between lift arm 162 and pivot extension 160, and having a securing apparatus securing the rod in place. Pivot extension 160 in turn is fixedly secured to the underside of upper grid 142. Third pivot 172 pivotably secures upper grid 142 to a sidewall 138 of lid 112 in the same fashion described above for pivots 72a, b, towards the rearward portion of lid 112, by way of a rod 175 secured to opposite sides of upper grid 142 and extending outwardly therefrom and through respective holes 173 of upper lid 112, rod 175 being secured in place by a lock-nut (not shown), snap-fit into place, etc. Rod 175a, b can be secured by a nut, such as a wing-nut, can be snap-fit into place, or secured by any other comparable securing method to facilitate pivoting of upper grid 142 in response to movement of lid 112 between an open and closed position.

When grill 100 is closed, second pivot 170 and pivot 172 are in first positions E′ and F′ respectively. As a griller manually opens lid 112 clockwise as shown, upper grid 142, which is pivotably secured to lid 112, pivots upwardly with the opening of lid. 112. When lid 112 is fully opened, pivot 170 and pivot 172 travel upwardly and rearwardly (towards shaft or pivot 120) into second positions E″ and F″ respectively. When lid 112 is opened, lift arm 162 and pivot extension 160 are substantially in alignment, as lift arm 162 pivots upwardly in the clockwise direction around pivot 166, which is fixed relative to bowl 114, and pivot extension 160 pivots about second pivot 170 which is itself pivoting about first pivot 166 with lift arm 162. Employment of pivot extension 160 allows upper grid 142 to pivot upwardly to a higher level relative to lower grid 140, thereby allowing a greater amount of space between upper grid 142 and lower grid 140 in the open position.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

1. A multi-level barbecue grill comprising:
a base cavity having a front wall, a rear wall, a bottom wall and a pair of sidewalls extending upwardly from said bottom wall, said sidewalls, front wall, rear wall and bottom wall defining a cooking area of said grill, said cooking area able to incorporate a heat source therein;
a base-lid pivot;
a top lid positioned upwardly of said base cavity having a lid front wall, a lid rear wall, a top wall, and a pair of opposing lid sidewalls, the rear wall of said lid being pivotally secured by said base-lid pivot to the rear wall of said base cavity for movement between a closed position and an open position, said lid being pivotable relative to said base cavity, and the sidewalls of said lid being adjacent to the sidewalls of said base cavity when said lid is in the closed position relative to said base cavity;
a lower cooking grid for extending over the cooking area opposite to said bottom wall of said base cavity between said sidewalls, and between said front wall and said rear wall;
a first pair of pivots disposed between the rear end of said upper grid and opposing lid sidewalls;
an upper pivotable grid secured to said top lid on said first pair of pivots, said upper grid being parallel to said lower grid;
a pair of oppositely disposed pivot extensions having a pivotable end and a non-pivotable end disposed oppositely from each other on said lower grid, said non-pivotable end secured to said lower grid, and extending upwardly from said lower grid;
a pair of lift arms having a pivotable first end and a pivotable second end, each of said first ends being pivotally secured to said upper grid and said second end being pivotally secured to one of said pair of pivot extensions;
a second pair of pivots disposed between the pivotable end of the respective pivot extensions and the second end of the respective lift arms; and
a third pair of pivots disposed on opposite sides of said upper grid, between said upper grid and said first end of the respective lift arms;
said upper grid and said lower cooking grid being parallel and relatively close to each other when said top lid is in the closed position, and said upper grid pivoting to a position parallel to and relatively far from said lower cooking grid in response to the pivoting of said top lid to the open position.

2. The barbecue grill according to claim 1 wherein said lower grid further comprises a pair of oppositely disposed indentations with a supporting structure extending thereacross to accommodate said pivot extensions.

3. The barbecue grill according to claim 1 wherein said sidewalls of said base cavity additionally comprise at least one pair of oppositely disposed lower grid supports for supporting said lower grid within said cooking area of said base cavity.

4. The barbecue grill according to claim 1 wherein said second pair of pivots are stationary relative to a lateral or vertical direction.

5. The barbecue grill according to claim 1 wherein said third pair of pivots is laterally and vertically movable between a first position and a second position.

6. The barbecue grill according to claim 5 wherein said third pair of pivots is in said first position when said grill is in the closed position and in said second position when said grill is in the open position.

7. The barbecue grill according to claim 1 wherein said first pair of pivots is laterally and vertically moveable between a first position and a second position.

8. The barbecue grill according to claim 7 wherein said first pair of pivots is in said first position when said grill is in the closed position and in said second position when said grill is in the open position.

9. The barbecue grill according to claim 1 wherein said lid and base cavity each further includes an edge having a lip, the lip of said lid and the lip of said base cavity being flush against each other when said top lid is in the closed position to provide a seal for said barbecue grill.

10. The barbecue grill according to claim 9 wherein said lip of said lid is inwardly beveled to create a seal for said barbecue grill when said lid is in the closed position, and said lip of said lid overlaps said lip of said cavity.

11. The barbecue grill according to claim 1 wherein the distance along an x-axis between the pivot of said respective pivot extensions and said respective lift arms, and the pivot of said respective lift arms and said respective upper grids is within 10% of the distance between the first pair of pivots of said upper grid sidewalls and said base-lid pivot.

12. The barbecue grill according to claim 11 wherein the distance along an x-axis between said second pair of pivots of said pivot extensions and said lift arms, and said third pair of pivots of said lift arms and said upper grid, is the same as the distance between said first pair of pivots of said upper grid and said lid and the base-lid pivot of said lid and said base cavity.

13. The barbecue grill according to claim 1 wherein the angle between said second pair of pivots of said pivot extension and said lift arm, and said third pair of pivots of said lift arm and said upper grid is within 10° of the angle between said first pair of pivots of said upper grid and said lid, and said base-lid pivot of said lid and said base cavity.

14. The barbecue grill according to claim 1 wherein the angle between said second pair of pivots of said pivot extensions and said lift arm, and said third pair of pivots of said lift arms and said upper grid is the same as the angle between said first pair of pivots of said upper grid and said lid, and said base-lid pivot of said lid and said base cavity.

15. The barbecue grill according to claim 1 wherein said base cavity further includes a flavorizer tray within said cooking area and beneath said lower grid.

16. The barbecue grill according to claim 1 and further including a plurality of support legs secured to said base cavity.

17. The barbecue grill according to claim 1 wherein said plurality of support legs extend downwardly from said base cavity to support said grill and are retractable for storage of said grill.

18. The barbecue grill according to claim 17 and further including a pin and lock assembly, wherein said plurality of support legs are able be locked in place in either an extended manner or a retracted manner by said pin and lock assembly.

19. A multi-level barbecue grill comprising:
a base cavity having a front wall, a rear wall, a bottom wall and a pair of sidewalls extending upwardly from said bottom wall, said sidewalls, front wall, rear wall and bottom wall defining a cooking area of said grill, said cooking area able to incorporate a heat source therein;
a base-lid pivot;
a top lid positioned upwardly of said base cavity having a lid front wall, a lid rear wall, a top wall, and a pair of opposing lid sidewalls, the rear wall of said lid being pivotably secured by said base-lid pivot to the rear wall of said base cavity for movement between a closed position and an open position, said lid being pivotable relative to said base cavity, the sidewall of said lid being adjacent to the sidewalls of said base cavity when said lid is in the closed position relative to said base cavity;
a lower cooking grid for extending over the cooking area opposite to said bottom wall of said base cavity between said sidewalls and between said front wall and said rear wall;
a pair of oppositely disposed pivot extensions having a pivotable end and a non-pivotable end disposed oppositely from each other on said upper grid, said non-pivotable end secured to said upper grid, and extending downwardly from said upper grid;
a pair of lift arms having a pivotable first end and a pivotable second end, each of said first ends being pivotally secured to said pivotable end of the respective pivot extension and said second end being pivotally secured to said lower grid;
a first pair of pivots disposed between the rear end of said upper grid and opposing lid sidewalls;
a second pair of pivots disposed between the pivotable end of the pivot extensions and the first end of the respective lift arms; and
a third pair of pivots disposed on opposite sides of said lower grid pivotally securing said lower grid and said second end of the respective lift arms;
an upper pivotable grid secured to said top lid on said first pair of pivots, said upper grid being parallel to said lower grid;
said upper grid and said lower cooking grid being parallel and relatively close to each other when said top lid is in the closed position, and said upper grid pivoting to a position parallel to and relatively far from said lower cooking grid in response to the pivoting of said top lid to the open position.

20. A pivotable grid assembly for use with a barbecue grill having a base cavity and a lid, said grid assembly being movable between a closed condition and an open condition and comprising:
a lower grid secured to said base cavity;
an upper pivotable grid pivotably secured to said lid and parallel to said lower grid; and
a pivot assembly secured to said upper grid and said lower grid, said pivot assembly including a pair of oppositely disposed pivot extensions both being secured to one of said upper grid and said lower grid and having a free end, a pair of lift arms each pivotally connected to both the free end of said pivot extension and to the other of said upper grid and said lower grid, for pivoting said upper grid between an upper position and a lower position relative to said lower grid, a pair of lower pivots pivotally securing said pivot extension free end to said lift arm when said pivot extension is secured to said lower grid or said lower grid to said lift arm, and a pair of upper pivots pivotally securing said lift arm to said upper grid or said lift arm to said pivot extension free end when said pivot extension is secured to said upper grid.

21. The pivotable grid assembly according to claim 20 wherein said pair of pivot extensions are oppositely disposed on said lower grid and extend upwardly from said lower grid for raising the level of said pair of lower pivots, each of said pair of pivot extensions being pivotally secured to one of said pair of lift arms, said lift arms being pivotally secured to said upper grid by said pair of upper pivots.

22. The pivotable grid assembly according to claim 20 wherein said pair of lift arms are pivotally secured to said lower grid and are oppositely disposed on opposite sides of said lower grid, and extend from a first position substantially parallel to said lower grid when said barbecue grill is in the closed condition to a second position substantially perpendicular to said lower grid in response to movement of the barbecue grill to the open condition, each of said pair of lift arms being pivotally secured to one of said pair of pivot extensions at said free end of said pair of pivot extensions, said pair of pivot extensions being secured to the underside of said upper grid.

23. A grid assembly for use with a barbecue grill, the grill having a lower bowl, an upper lid pivotally attached to the bowl for opening and closing the bowl, a lower cooking grid extending over and adjacent to the bowl, and an upper warming grid pivotally attached to the lid, the upper warming grid being proximate and parallel to the lower cooking grid when the lid closes the bowl and being distal from and parallel to the lower cooking grid when the lid open the bowl, the grid assembly comprising:
a pivot extension device for establishing a first pivot axis above and proximate to the location of the lower cooking grid;
a lift arm device pivotal about said first pivot axis for establishing a second pivot axis for the upper warming grid, said lift arm device pivoting about said first pivot axis from a closed position when the lid closes the bowl for positioning said first pivot axis close to the lower cooking grid, to an open position more distal from the lower cooking grid than said first pivot axis in response to movement of the lid to open the bowl;
the upper warming grid pivoting about said second pivot axis and pivoting relative to the lid in response to movement of the lid to open the bowl to provide a greater distance between the lower cooking grid and the upper warming grid in the absence of said second pivot axis, to enable a more extensive upper cooking grid while providing improved access to all portions of the lower cooking grid.
